(19) United States
(12) Patent Application Publication
(10) Pub. No.: US 2011/0288782 A1
(43) Pub. Date: Nov. 24, 2011

(54) SYSTEM FOR DETERMINING STATE AND ACTION OF HUMAN BODY AND METHOD OF DETERMINING STATE OF HUMAN BODY, USING AN OPTICAL SIGNAL

(75) Inventor: Man-Gyu Park, Chungcheongnam-Do (KR)

(73) Assignee: FNT CO., LTD., (KR)

(21) Appl. No.: 13/146,861

(22) PCT Filed: Dec. 9, 2009
(86) PCT No.: PCT/KR09/07367

§ 371 Date: Jul. 28, 2011

(51) Int. Cl. G06F 19/00

(52) U.S. Cl. 702/19

(57) ABSTRACT

Disclosed herein is a system for determining the state and action of the human body using an optical signal. The system includes an optical signal transmission module configured to generate and output the optical signal, an optical signal transfer module configured to include at least one optical signal transfer path that is wearable on a region of the human body and that has at least one cut portion, and a human body state analysis module configured to determine a variation in the state of the human body by calculating the light transmission ratio of the at least one optical signal transfer path which varies depending on the gap of the at least one cut portion of the at least one optical signal transfer path. The gap varies depending on a variation in a circumference of the region of the human body.

### TECHNICAL FIELD

The present invention relates, in general, to a technique for determining the state of the human body and, more particularly, to a system for determining the state and action of the human body and a method of determining the state of the human body, using an optical signal, which are capable of determining a variation in the state of at least one region of the human body, the posture of the human body, and the moving state of the human body.

### BACKGROUND ART

So-called motion detection techniques for determining the state of the human body include a technique for determining the state of the human body based on human body signals sensed using a number of marks and a technique for determining the state of the human body by photographing the motion of the human body using a number of cameras.

The technique using marks has the inconvenience of directly attaching the marks to the skin, and has the drawback of simply determining only the motion of the human body but not determining the degree of strength that is applied to a region of the human body and the drawback of not determining three-dimensional (3D) variation in a region of the human body. The technique using cameras has the drawback of being expensive because expensive cameras are used, and the drawback of not determining 3D variation in a region of the human body, like the technique using marks. Furthermore, the two techniques are difficult to apply at industrial sites and to apply in urgent and dangerous environments, such as the scene of a fire and emergency situations.

### DISCLOSURE

### Technical Problem

Accordingly, an object of the present invention is to provide a system for determining the state of the human body, which can be attached to at least one region of the human body and then simply and rapidly determine a variation in the state of the at least one region of the human body, the posture of the human body and the moving state of the human body, and can further be applied to industrial sites or dangerous environments, and a method for determining the state of the human body.

### Technical Solution

In order to accomplish the above object, a system for determining the state and action of the human body using an optical signal may include an optical signal transmission module, an optical signal transfer module, and a human body state analysis module. The optical signal transmission module may generate and output the optical signal. The optical signal transfer module may include at least one optical signal transfer path that is wearable on a region of the human body and that has at least one cut portion. The human body state analysis module may determine variation in the state of the human body by calculating the Light Transmission Ratio (LTR) of the at least one optical signal transfer path which varies depending on the gap of the at least one cut portion of the at least one optical signal transfer path. Here, the gap of the at least one cut portion of the at least one optical signal transfer path may vary based on a variation in the circumference of the region of the human body.

A system for determining the state of the human body may be implemented using a sensing apparatus for determining the state of the human body and an apparatus for determining the state of the human body, which are separate from each other. The sensing apparatus for determining the state of the human body may include an optical signal transmission module configured to generate and output an optical signal, an optical signal transfer module configured to have at least one optical signal transfer path that is wearable on a region of the human body and that has at least one cut portion, and a data transmission module configured to send data, generated based on the optical signal output from the optical signal transfer module, to the outside. Here, the gap of the at least one cut portion of the at least one optical signal transfer path may vary based on a variation in the circumference of the region of the human body.

The apparatus for determining the state of the human body may determine the state of the human body based on processed data received from the sensing apparatus for determining the state of the human body. The apparatus for determining the state of the human body may include a reception module for receiving the processed data from the sensing apparatus for determining the state of the human body and an operation module for calculating the LTR of the at least one optical signal transfer path based on the received and processed data and for determining a variation in the state of the human body based on the calculated LTR.

In order to accomplish the above object, a method of determining the state of the human body may include generating and outputting an optical signal, transferring the optical signal using at least one optical signal transfer path being wearable on a region of the human body and having at least one cut portion, and determining a variation in the state of the human body based on the LTR of the at least one optical signal transfer path which varies depending on the gap of the at least one cut portion of the at least one optical signal transfer path. Here, the gap of the at least one cut portion of the at least one optical signal transfer path may vary based on a variation in the circumference of the region of the human body.

The method of determining the state of the human body according to the embodiment of the present invention may be implemented by executing a computer program for executing the method of determining the state of the human body which is stored in a computer-readable recording medium.

### Advantageous Effects

As described above, the system for determining the state and action of the human body and the method of determining the state of the human body, using an optical signal according to the present invention have the advantage of simply and rapidly determining the state of a portion of the human body, the posture of the human body, and the moving state of the human body, compared to conventional techniques. Furthermore, when a wireless communication network is used, the system for determining the state and action of the human body and the method of determining the state of the human body, using an optical signal according to the present invention have the advantage of simply and rapidly determining the state of a portion of the human body, the posture of the human body and the moving state of the human body even over a long distance.

### DESCRIPTION OF DRAWINGS

FIG. 1 is a block diagram of a system for determining the state and action of the human body using an optical signal according to an embodiment of the present invention;

FIG. 2 is a schematic diagram showing the configuration of the optical signal transfer module shown in FIG. 1;

FIG. 3 is a conceptual diagram illustrating the optical signal transfer characteristics of the optical signal transfer module;

FIG. 4 is a graph showing the LTR of the optical signal transfer module;

FIG. 5 shows the human body state analysis module integrated with clothing;

FIG. 6 is a block diagram of the human body state analysis module shown in FIG. 1;

FIG. 7 is a flowchart illustrating a method of determining the state of the human body according to an embodiment of the present invention; and

FIG. 8 is a flowchart illustrating a process of determining a variation in the state of the human body shown in FIG. 7.

### BEST MODE

The method of determining the state of the human body according to an embodiment of the present invention may also be implemented in a computer-readable recording medium in the form of computer-readable code. The method of determining the state of the human body according to an embodiment of the present invention may be implemented by executing a computer program for executing the method of determining the state of the human body which is stored on a computer-readable recording medium.

### MODE FOR INVENTION

In order to fully understand the present invention, the advantages in terms of the operation of the present invention, and the object achieved by implementing the present invention, reference should be made to the accompanying drawings illustrating preferred embodiments of the present invention and the content shown in the accompanying drawings.

In this specification, the case where one element ‘sends’ data or a signal to another element means that the former element may directly send the data or signal to the latter element, or may send the data or signal to the latter element via at least one other element.

The present invention will be described in detail below by describing the preferred embodiments of the present invention with reference to the accompanying drawings. The same reference numerals presented in each drawing denote the same elements.

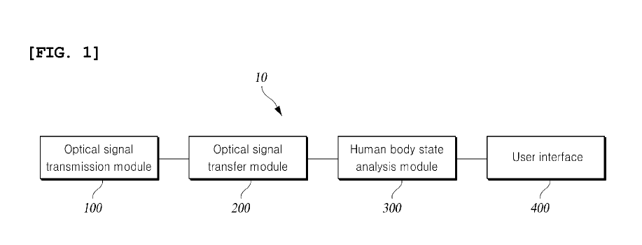

FIG. 1 is a block diagram of a system 100 for determining the state and action of the human body using an optical signal according to an embodiment of the present invention. Referring to FIG. 1, the system 10 for determining the state of the human body includes an optical signal transmission module 100, an optical signal transfer module 200, a human body state analysis module 300, and a user interface 400.

The optical signal transmission module 100 may generate and output optical signals. Although not shown in FIG. 1, the optical signal transmission module 100 may include an optical signal generator and an optical signal transmitter. The optical signal transmission module 100 may be implemented using LEDs for generating optical signals of specific wavelengths. However, the scope of the present invention is not limited thereto.

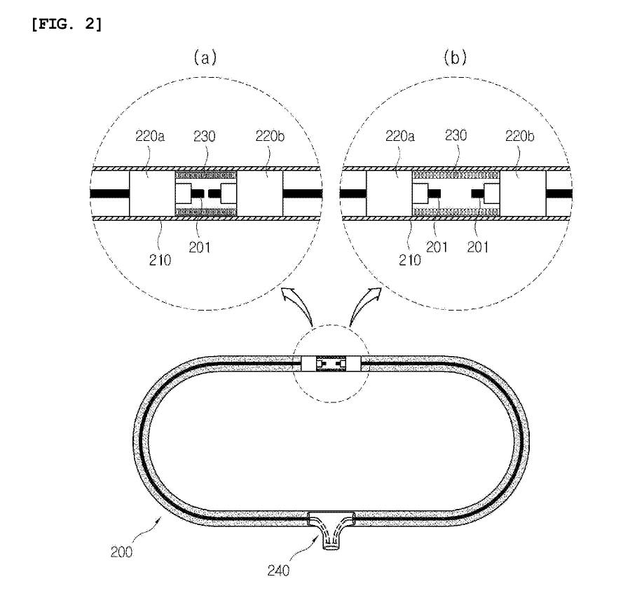

The optical signal transfer module 200 may be worn on a region of the human body, and may be provided with at least one optical signal transfer path having at least one cut portion. FIG. 2 is a schematic diagram showing the configuration of the optical signal transfer module 200, including one optical signal transfer path, shown in FIG. 1. As schematically shown in FIG. 2, the optical signal transfer path includes a signal transfer path body 210, one or more connectors 220a and 220b for supporting optical fiber, and an elastic member 230.

The gap of the cut portion of the at least one optical signal transfer path may vary depending on a variation in the circumference of any one region of the human body on which the optical signal transfer module 200 is worn. The optical signal transfer path may be implemented using optical fiber having at least one cut portion. However, the scope of the present invention is not limited thereto.

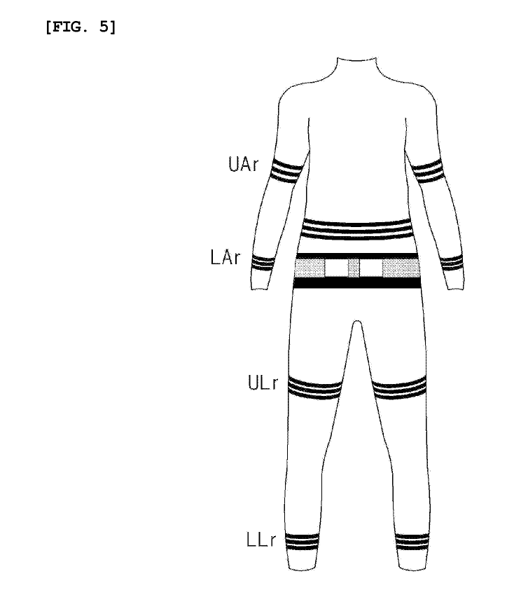

The optical signal transfer path body 210 functions to support the connectors 220a and 220b for supporting the optical fiber and the elastic member 230, and forms the shell of the optical signal transfer path. Furthermore, the optical signal transfer path body 210 may be provided to be able to be worn on at least one region of the human body. For example, the optical signal transfer path body 210 may be worn on one of regions, such as an arm, the waist, the inside of a thigh, and the calf of the human body. Accordingly, it is preferred that the optical signal transfer path body 210 be formed of a rubber band. When the optical signal transfer path is fabricated in the form shown in FIG. 5, the optical signal transmission module 100 may be worn on the necessary region of the human body using the optical signal transfer path body 210 as a rubber band. In contrast, when the optical signal generation module 200 is provided to be integrated with clothing, etc., the optical signal transfer path body 210 as a rubber band may be sewed onto clothing, etc.

The pair of connectors 220a and 220b for supporting the optical fiber are provided within the optical signal transfer path body 210, and supports the optical fiber 201 so that the gap of the at least one cut portion varies depending on a variation in the circumference of the human body. In the case of FIG. 2, the optical fiber 201 is cut in a single location, and accordingly the pair of connectors 220a and 220b for supporting the optical fiber may be provided at the single location. However, the scope of the present invention is not limited thereto. For example, the optical fiber 201 may have two or more cut portions.

The elastic member 230 is coupled to the pair of connectors 220a and 220b for supporting the at least one optical fiber, and then the connectors 220a and 220b for supporting the optical fiber are elastically biased in the direction in which they approach each other. Accordingly, when the optical signal transfer module 200 is worn on any one region, e.g., a leg, of the human body, first, both free ends of the cut optical fiber 201 are close to each other or come into contact with each other, as shown in FIG. 2(a). When walking or running is performed, both free ends of the cut optical fiber 201 become wider because of a variation in the circumference of the human body, as shown in FIG. 2(b). When the action is stopped, both free ends of the cut optical fiber 201 are brought close to each other or brought into contact with each other by means of the elastic member 230, as shown in FIG. 2(a). The quantity of optical signal transferred via both free ends of the optical fiber 201 is varied by means of the repetitive mechanism.

It is preferred that a connection unit 240 between the optical signal transmission module 100 and the human body state analysis module 300 of the optical signal transfer path be made of stiff material capable of protecting the optical fiber 201 externally to ensure stable connection with the optical signal transmission module 100 and the human body state analysis module 300. Here, the connection unit 240, as shown in FIG. 2, may be used to fasten and connect the ends of the optical fiber 201, and may also be a portion where a sensor for transferring an optical signal will be attached. Accordingly, the connection unit 240 does not need to be limited to the illustrated shape.

The system 10 for determining the state of the human body according to the embodiment of the present invention may determine a variation in the state of a region of the human body on which the optical signal transfer module 200 is worn, based on variation in the optical signal, i.e., a Light Transmission Rate (LTR), transferred through the optical signal transfer module 200 according to the mechanism.

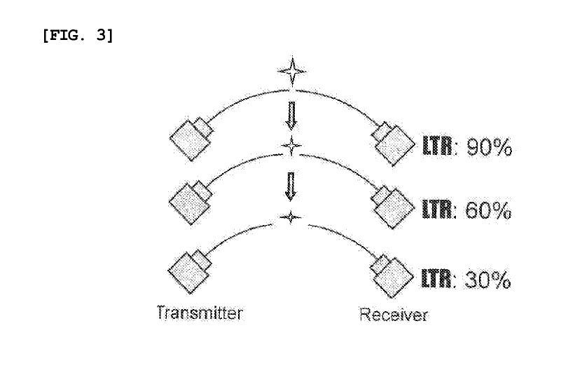

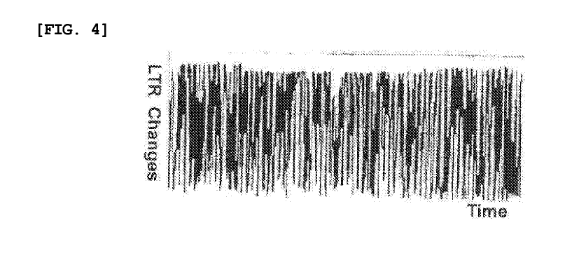

FIG. 3 is a conceptual diagram illustrating the optical signal transfer characteristics of the optical signal transfer module 200, and FIG. 4 is a graph showing the LTR of the optical signal transfer module 200. Referring to FIG. 3, it can be seen that the LTR which is the ratio of an optical signal received by an optical signal receiver, to an optical signal output from an optical signal transmitter gradually decreases with an increase in the circumference of a region of the human body on which the optical signal transfer module 200 is worn. Referring to FIG. 4, it can be seen that the LTR of the optical signal transfer module 200 varies depending on a variation in the circumference of a region of the human body, i.e., a variation in the state of a region of the human body, on which the optical signal transfer module 200 is worn.

FIG. 5 shows the system 10 for analyzing the state of the human body, which is integrated with clothing. In FIG. 5, each of the white lines indicates an optical signal transfer path to be worn on a region of the human body. The optical signal transmission module 100 and the human body state analysis module 300 may be included in the belt portion of the clothing.

In FIG. 5, even when only the LTRs of an optical signal transfer path UAr on the upper portion of the right arm, an optical signal transfer path LAr on the lower portion of the right arm, an optical signal transfer path ULr on the upper portion of the right leg, and an optical signal transfer path LLr on the lower portion of the right leg are used, the basic state of the human body may be determined. A simple example in which the system 10 for determining the state of the human body determines the state of the human body using the LTRs of the optical signal transfer paths for a fixed posture and a periodic moving state will now be described.

First, a process of setting the LTRs of respective optical signal transfer paths in a safely lying-down state to an initial reference value and then determining a fixed posture of the human body will be described. For example, a sitting posture may be determined based on the LTR of the optical signal transfer path worn on the waist region of the human body, and a standing posture may be determined based on the LTRs of the optical signal transfer paths worn on the upper and lower portions of the leg of the human body and the waist portion of the human body.

A walking or running state which is a periodic moving state may be determined by generally taking the LTRs of all the optical signal transfer paths, worn on the nine regions shown in FIG. 5, into consideration. The walking state and the running state have different LTRs and different variation cycles.

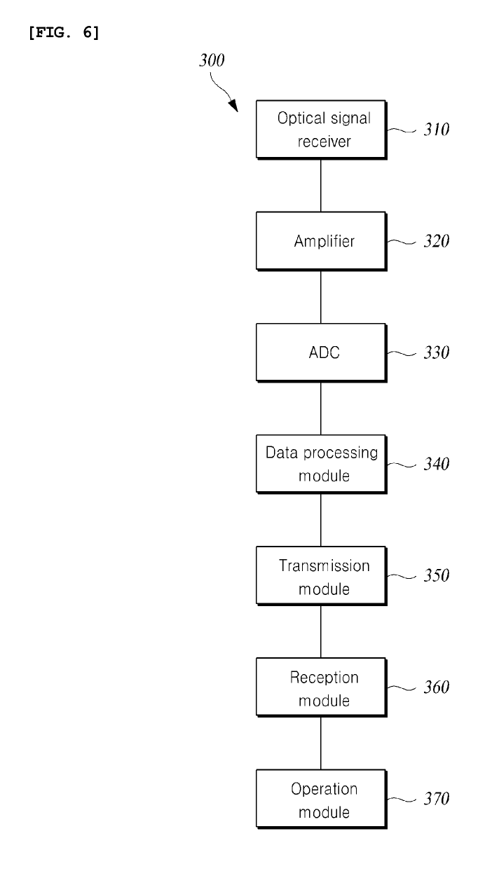

FIG. 6 is a block diagram of the human body state analysis module 300 shown in FIG. 1. The human body state analysis module 300 may determine a variation in the state of the human body by calculating the LTR of the at least one optical signal transfer path which varies depending on the gap of the at least one cut portion of the at least one optical signal transfer path of the optical signal transfer module 200. Referring to FIG. 6, the human body state analysis module 300 may include an optical signal receiver 310, an amplifier 320, an Analog/Digital Converter (ADC) 330, a data processing module 340, a transmission module 360, a reception module 360, and an operation module 370.

The optical signal receiver 310 may receive an optical signal output from the optical signal transfer path of the optical signal transfer module 200, convert the received optical signal into an electrical signal, and output the electrical signal. The optical signal receiver 310 may be implemented using a photodiode which is driven in response to the received optical signal. However, the scope of the present invention is not limited thereto.

The amplifier 320 may amplify the signal output from the optical signal receiver, and output the amplified signal. The ADC 330 may convert the output signal of the amplifier 320 into a digital signal, and output the digital signal. The data processing module 340 may process the digital signal output from the ADC 330, and output the processed signal. The data processing performed by the data processing module 340 may include processing that is performed to sample a digital signal at a specific sampling rate in order to reduce the amount of data processing. The data processing performed by the data processing module 340 may further include processing that is performed to convert the digital signal of the ADC 330 into a signal in a specific communication standard form. This is merely illustrative, and the scope of the present invention is not limited thereto.

The transmission module 360 may send the processed data to the outside. The transmission module 360 may send the processed data to the outside using a wireless communication network. The wireless communication network may be a zigbee communication network, a bluetooth communication network, a WiBro communication network, or a wireless Internet network, but the scope of the present invention is not limited thereto.

The reception module 360 may receive the data from the transmission module 360, and output the received data. The operation module 370 may calculate the LTR of the optical signal transfer path based on the received data, and determine a variation in the state of a region of the human body on which the optical signal transfer path is worn, based on the calculated LTR. When more than one optical signal transfer path is worn on several regions of the human body as described above, the operation module 370 may determine a variation in the state of each region of the human body on which the optical signal transfer path is worn, the posture of the human body, and the moving state of the human body.

The human body state analysis module 300 may be implemented using a single apparatus, and be worn on the belt portion of the human body shown in FIG. 5. In this case, the transmission module 360 and the reception module 360 that connect the data processing module 340 with the operation module 370 may be unnecessary elements in the human body state analysis module 300.

However, the optical signal receiver 310, the amplifier 320, the ADC 330, the data processing module 340, and the transmission module 360 may be implemented as a separate apparatus for sensing the state of the human body, which is attached to the human body, and the reception module 360 and the operation module 370 may be implemented as a separate apparatus for determining the state of the human body, which is separate from the human body. Here, the apparatus for sensing the state of the human body and the apparatus for determining the state of the human body may be interconnected by the transmission module 360 and the reception module 360 over a wireless communication network. Then, when the system 10 for determining the state of the human body according to the embodiment of the present invention is used, an observer may monitor the state of the human body at a location at a distance away from the human body.

Unlike conventional techniques for determining the state of the human body, the system 10 for determining the state of the human body may be applied to industrial sites based on the characteristics of the system 10 for determining the state of the human body according to the embodiment of the present invention. Furthermore, the system 10 for determining the state of the human body according to the embodiment of the present invention 10 is advantageous in that it can be used even in dangerous and urgent environments, such as the scene of a fire, the scene of an accident, an underwater environment, and outer space.

Although not shown in FIG. 1, the user interface 400 connected to the human body state analysis module 300 may include at least one of various manipulation means for manipulating the system 10 for determining the state of the human body, a display device for displaying various types of data based on the operating status of the system 10 for determining the state of the human body, including the state of the human body, determined to be a calculated LTR, and various display means for displaying the operating status of the system 10 for determining the state of the human body.

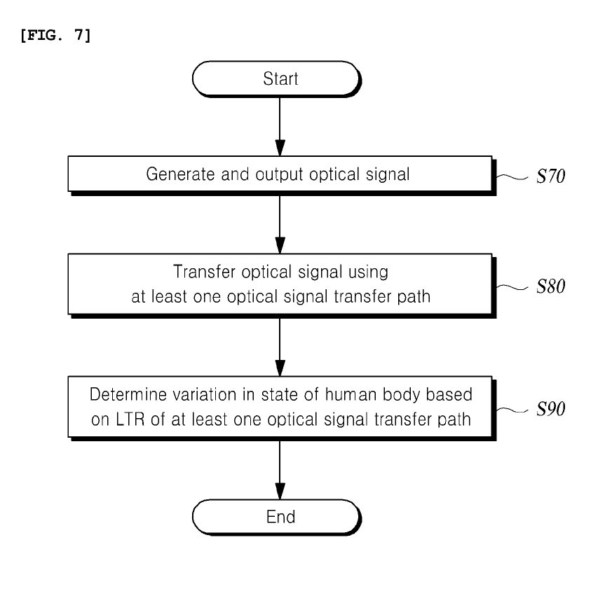

FIG. 7 is a flowchart illustrating a method of determining the state of the human body according to an embodiment of the present invention. The process of determining the state of the human body according to the embodiment of the present invention will now be described with reference to the above-described drawings.

When the optical signal transmission module 100 generates and outputs an optical signal at step S70, the optical signal transfer module 200 transfers the optical signal of the optical signal transmission module 100 to the human body state analysis module 300 via at least one optical signal transfer path at step S80. The human body state analysis module 300 may calculate the LTR of the at least one optical signal transfer path and determine a variation in the state of the human body based on the calculated LTR at step S90.

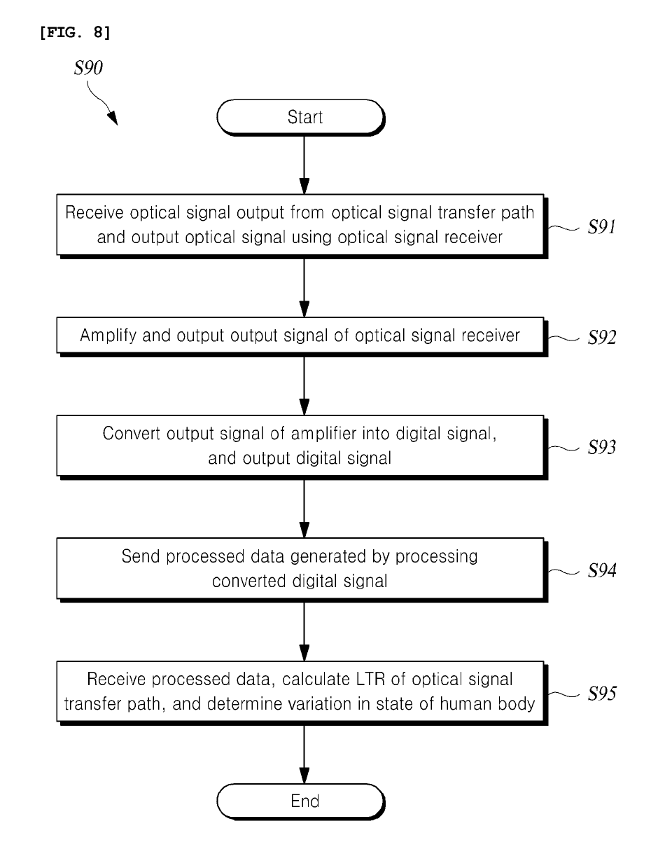

FIG. 8 is a flowchart illustrating a process of determining a variation in the state of the human body shown in FIG. 7. The process of determining the variation in the state of the human body will now be described with reference to the above-described drawings.

When an optical signal, received from an optical signal transfer path, is converted into an electrical signal and then the electrical signal is output using the optical signal receiver 310 at step S91, the amplifier 320 amplifies and outputs the output signal of the optical signal receiver 310 at step S92. The ADC 330 converts the output signal of the amplifier 320 into a digital signal and outputs the digital signal at step S93.

The data processing module 340 processes the digital signal and then outputs the processed signal and the transmission module 360 sends the processed data at step S94. The reception module 360 receives the processed data, and outputs the received data. The operation module 370 calculates the LTR of the at least one optical signal transfer path based on the received processed data and determines variation in the state of the human body based on the calculated LTR at step S95.

### INDUSTRIAL APPLICABILITY

The method of determining the state of the human body according to the embodiment of the present invention may be implemented in a computer-readable recording medium in the form of computer-readable code. The method of determining the state of the human body according to the embodiment of the present invention may be implemented by executing a computer program that executes the method of determining the state of the human body, which is stored on a computer-readable recording medium.

The computer-readable recording medium includes all types of recording devices in which data readable by a computer system is stored. For example, the computer-readable recording medium includes ROM, RAM, CD-ROM, a magnetic tape, a floppy disk, and an optical data storage device.

Furthermore, the computer-readable recording medium may be distributed amongst computer systems interconnected over a network, and the computer-readable code may be stored and executed in a distributed fashion. Furthermore, a functional program, code, and code segments for implementing the method of determining the state of the human body according to the embodiment of the present invention may be easily derived by programmers having ordinary skill in the art to which the present invention pertains.

Although the invention has been described in conjunction with embodiments shown in the drawings, it is merely illustrative. It will be appreciated by those having ordinary skill in the art that various modified/equivalent embodiments are possible from the above description. Accordingly, the technical scope of protection of the present invention should be determined by the following claims.

1. A system for determining a state and action of a human body using an optical signal, the system comprising:
an optical signal transmission module configured to generate and output the optical signal;
an optical signal transfer module configured to include at least one optical signal transfer path that is wearable on a region of the human body and that has at least one cut portion; and
a human body state analysis module configured to determine a variation in the state of the human body by calculating a Light Transmission Ratio (LTR) of the at least one optical signal transfer path which varies depending on a gap of the at least one cut portion of the at least one optical signal transfer path;
wherein the gap of the at least one cut portion of the at least one optical signal transfer path varies depending on a variation in a circumference of the region of the human body.

2. The system according to claim 1, wherein the at least one optical signal transfer path comprises optical fiber having at least one cut portion, the gap of the at least one cut portion of the optical fiber varying depending on the variation in the circumference of the region of the human body.

3. The system according to claim 1, wherein the human body state analysis module comprises:
an optical signal receiver for receiving the optical signal output from the at least one optical signal transfer path, converting the received optical signal into an electrical signal, and outputting the electrical signal;
an amplifier for amplifying and outputting the signal output from the optical signal receiver;
an Analog/Digital Converter (ADC) for converting the signal, output from the amplifier, into a digital signal and outputting the digital signal; and
an operation module for calculating the LTR of the at least one optical signal transfer path based on the digital signal output from the ADC and determining the variation in the state of the human body based on the calculated LTR.

4. The system according to claim 3, wherein the human body state analysis module further comprises an interface module connected between the ADC and the operation module.

5. A method of determining a state and action of a human body using an optical signal, the method comprising:
generating and outputting the optical signal;
transferring the optical signal using at least one optical signal transfer path that is wearable on a region of the human body and that has at least one cut portion; and
calculating an LTR of the at least one optical signal transfer path which varies depending on a gap of the at least one cut portion of the at least one optical signal transfer path, and determining a variation in the state of the human body based on the calculated LTR;
wherein the gap of the at least one cut portion of the at least one optical signal transfer path varies depending on a variation in a circumference of the region of the human body.

6. The method according to claim 5, wherein the at least one optical signal transfer path comprises optical fiber having at least one cut portion, the gap of the at least one cut portion of the optical fiber varying depending on the variation in the circumference of the region of the human body.

7. The method according to claim 6, wherein the analyzing the variation in the state of the human body comprises:
receiving the optical signal output from the at least one optical signal transfer path, converting the received optical signal into an electrical signal, and outputting the electrical signal using an optical signal receiver;
amplifying and outputting the signal output from the optical signal receiver;
converting the amplified and output signal into a digital signal, and outputting the digital signal; and
calculating the LTR of the at least one optical signal transfer path based on the output digital signal, and determining the variation in the state of the human body based on the calculated LTR.

8. A method of determining a state and action of a human body using an optical signal, the method comprising:
generating and outputting the optical signal;
transferring the optical signal using at least one optical signal transfer path that is wearable on a region of the human body and that has at least one cut portion; and
sending data, generated based on the optical signal output from the at least one optical signal transfer path, to an outside;
wherein the gap of the at least one cut portion of the at least one optical signal transfer path varies depending on a variation in a circumference of the region of the human body.

9. The method according to claim 8, wherein the at least one optical signal transfer path comprises optical fiber having at least one cut portion, the gap of the at least one cut portion of the optical fiber varying depending on the variation in the circumference of the region of the human body.

10. The method according to claim 9, wherein the sending the data, generated based on the optical signal output from the at least one optical signal transfer path, to an outside comprises:
converting the optical signal, received from the at least one optical signal transfer path, into an electrical signal, and outputting the electrical signal using an optical signal receiver;
amplifying and outputting the signal output from the optical signal receiver;
converting the amplified and output signal into a digital signal, and outputting the digital signal;
processing and outputting the digital signal; and
sending the processed data to an outside.

11. The method according to claim 8, further comprising receiving the processed data, and determining the state of the human body based on the received and processed data.

12. The method according to claim 11, wherein the determining the state of the human body based on the received and processed data comprises:
receiving the processed data output from the optical signal transfer path; and
calculating an LTR of the at least one optical signal transfer path based on the received and processed data, and determining variation in the state of the human body based on the calculated LTR.
